(19) United States
(12) Patent Application Publication
(10) Pub. No.: US 2017/0154469 A1
(43) Pub. Date: Jun. 1, 2017

(54) Method and Device for Model Rendering

(71) Applicants: Le Holdings (Beijing) Co., Ltd., Beijing (CN); LE SHI ZHI XIN ELECTRONIC TECHNOLOGY (TIANJIN) LIMITED, Beijing (CN)

(72) Inventor: Xiaofei XU, Beijing (CN)

(21) Appl. No.: 15/247,509

(22) Filed: Aug. 25, 2016

Related U.S. Application Data
(63) Continuation of application No. PCT/CN2016/088716, filed on Jul. 5, 2016.

(30) Foreign Application Priority Data
Dec. 1, 2015 (CN) 201510870852.0

(51) Int. Cl. G06T 19/00; G06T 1/20

(52) U.S. Cl. CPC G06T 19/006; G06T 1/20

(57) ABSTRACT

One embodiment of the present application provides a method and an electronic device for model rendering, wherein the method comprises: obtaining virtual object models of virtual objects built for a virtual-reality (VR) scene; transforming a coordinate vector in a local coordinates system of each virtual object into a coordinate vector in a camera coordinates system; creating a view rod of the virtual-reality scene to obtain the virtual object models in the view rod according to the view rod and the coordinate vector in the camera coordinates system of each of the virtual object models; and rendering each of the virtual object models in the view rod with a sequence from far to near according to a distance from a camera position so as to display the virtual-reality scene. The embodiment of the present disclosure improves the efficiency and the display effect of model rendering.

### CROSS REFERENCE TO RELATED APPLICATIONS

The disclosure is a continuation of International Application No. PCT/CN2016/088716, filed on Jul. 5, 2016, which is based upon and claims priority to Chinese Patent Application No. 201510870852.0, titled “METHOD AND DEVICE FOR MODEL RENDERING”, filed on Dec. 1, 2015, the entire contents of which are incorporated herein by reference.

### TECHNICAL FIELD

The present application relates to the technique field of virtual-reality, e.g. to a method and an electronic device for model rendering.

### BACKGROUND

Virtual-reality (VR) means that a virtual environment with lifelike vision, hearing, touching, etc., generated by high technology means of which the core is the computer technology. The user may interact with the object in VR via the display terminal.

To implement VR, it is needed to digitally describe the VR scene and to build the three-dimension (3D) model of the VR scene.

Model rendering relates to the process in which the display terminal obtains the 3D model of the VR scene, and illustrates according to the model information to display the VR scene.

The inventor discover in the process of implementing the invention that because a VR scene includes many virtual objects, the created 3D model usually includes many virtual object models of the virtual objects. The rendering sequence of the virtual object models affects the final rendered displaying effect, and the model rendered later would block the model rendered previous, so how to provide an efficient method for model rendering to improve the rendered displaying effect becomes a technique problem for the person having ordinary in the art to solve.

### SUMMARY

The present application provides a method and an electronic device for model rendering to solve the technique problem that the displaying effect of model rendering in conventional art has worse effect.

One embodiment of the present application provides a method for model rendering, comprising:

obtaining virtual object models of virtual objects built for a virtual-reality (VR) scene; transforming a coordinate vector in a local coordinates system of each virtual object into a coordinate vector in a camera coordinates system;

creating a view rod of the virtual-reality scene to obtain the virtual object models in the view rod according to the view rod and the coordinate vector in the camera coordinates system of each of the virtual object models; and

rendering each of the virtual object models in the view rod with a sequence from far to near according to a distance from a camera position so as to display the virtual-reality scene.

One embodiment of the present application further provides a non-volatile computer-readable storage medium storing computer-executable instructions, and the computer-executable instructions are used for performing any of the aforementioned methods for model rendering in the present application.

One embodiment of the present application further provides an electronic device including: at least one processor; and a memory; wherein the memory stores instruction capable of being executed by the at least one processor, and the instructions are executed by the at least one processor so as to make the at least one processor to perform any of the aforementioned methods for model rendering in the present application.

The method and the electronic device for model rendering provided in the embodiments of the present application, by transforming the virtual object models in the obtained virtual-reality scene into a camera coordinates system and by creating a view rod, only renders the virtual object model in the view rod so as to improve the efficiency of rendering. The virtual objects are rendered in the sequence from far to near so that the virtual object model closer to the camera is rendered later and would not be blocked, so the display effect may be improved.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for model rendering in one embodiment of the present application;

FIG. 2 is a flowchart of a method for model rendering in another embodiment of the present application;

FIG. 3 is a schematic of a device for model rendering in one embodiment of the present application;

FIG. 4 is a schematic of a device for model rendering in another embodiment of the present application; and

FIG. 5 is hardware architecture of an electronic device for model rendering in one embodiment of the present application.

### DETAILED DESCRIPTION

For making the purpose, the technique solution, and the benefit of the embodiments of the present application more clear, the technique solution in the embodiment of the present application is to be described clearly and completely in combination with the drawings in the embodiment of the present application. It's obvious that the described embodiments are not all but part of the embodiments of the present application. The other embodiment obtained by one having ordinary skill in the art according to the embodiments of the present application without creative dedication should be in the scope protected by the present application.

The technique solution of the present application is mainly applied in a display terminal, a computer, a cell phone, a tablet computer, a wearable apparatus, etc.

In one embodiment of the present application, after the display terminal obtains each of the virtual object models in the virtual-reality scene module, the display terminal at first transforms each of the virtual object model into a camera coordinates system by coordinates transformation. Then, the display terminal creates a view rod, and only the virtual object model in the view rod are rendered and projected from the camera coordinates system to the two-dimension screen to render each of the virtual objects. The virtual object models not in the view rod are discarded so as to improve the rendering efficiency. Further, each virtual object is rendered with a sequence from far to near according to a distance from the camera, so the virtual object model closer to the camera is rendered later and is not blocked so as to improve the display effect of rendering.

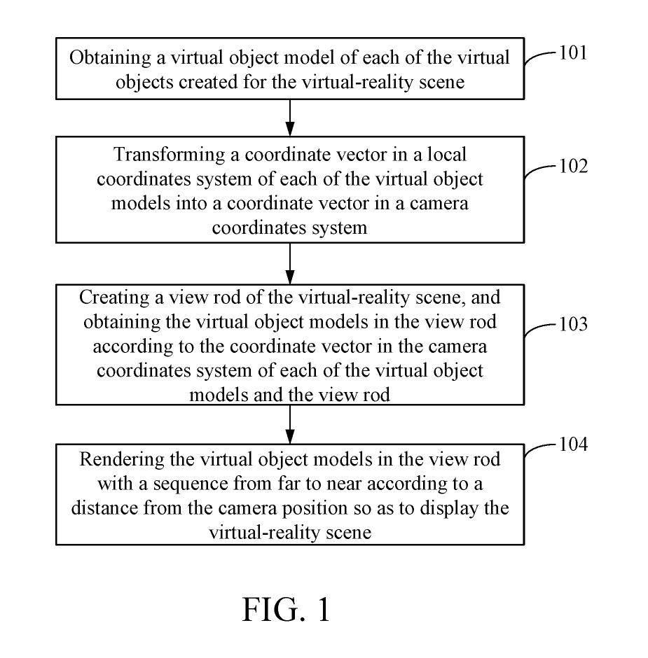

FIG. 1 is a flowchart of a method for model rendering in one embodiment of the present application, and the method may include the following steps:

101: the virtual object model of each of the virtual objects created for the virtual-reality scene is obtained.

The creation of the virtual object model is the same as the conventional art and will not be illustrated here.

For example, when the virtual-reality scene is a theatre scene, the virtual object models may include seat models, scene screen models, etc. Besides, when the virtual-reality scene is a beach scene, the virtual object models in the beach scene may include water, a yacht, a parasol, sands, etc.

102: a coordinate vector in a local coordinates system of each of the virtual object models is transformed into a coordinate vector in a camera coordinates system.

The camera coordinates system is also called the eye coordinates system, and refers to a vision space of watching objects by camera lens or eyes.

Because the virtual object model is created in the local coordinates system, it is needed to transform the virtual object model into the camera coordinates system for implementing the display of the virtual objects. Specifically, the coordinate vector in the local coordinates system of each of the virtual object models is transformed into the coordinate vector in the camera coordinates system.

The coordinate vector may be corresponding to the coordinates of any point in the virtual object model. For the sake of accuracy of computation, it may be corresponding to the center coordinates of the virtual object model.

Specifically, transforming the coordinate vector in the local coordinates system of the virtual object model into the coordinate vector in the camera coordinates system may be implemented by matrix transformation.

103: a view rod of the virtual-reality scene is created, and the virtual object models in the view rod will be obtained according to the coordinate vector in the camera coordinates system of each of the virtual object models and the view rod.

Because the field of vision of the camera is not infinite, so it's needed to create a view rod. The objects in the view rod can be projected to the view plane and the objects out of the view rod will be discarded.

The view rod may be represented by a matrix, and that is, a projection matrix. Hence, the virtual object models in the view rod may be obtained according to the coordinate vector in the camera coordinates system of each of the virtual object models and the projection matrix of the view rod.

104: the virtual object models in the view rod are rendered with a sequence from far to near according to a distance from the camera position so as to display the virtual-reality scene.

The virtual object models in the view rod are checked, and they are rendered with the sequence from far to near according to the distance from the camera position. That is, the virtual object models are projected from the camera coordinates system to the two-dimension screen to render graph on the two-dimension screen, so the display of the virtual-reality scene is implemented.

In one embodiment of the present application, each of the virtual object models in the virtual-reality scene is transformed into the camera coordinates system by coordinates transformation, and then the view rod is created. Only the virtual object models in the view rod are rendered and projected from the camera coordinates system to the two-dimension screen to render each of the virtual objects. The virtual object models out of the view rod are discarded so the efficiency of rendering is improved. Further, each virtual object is rendered with the sequence from far to near according to the distance from the camera, so the virtual object model closer to the camera is rendered later and wouldn't be blocked. Hence, the display effect of rendering is improved.

The coordinates systems usually include: the local coordinates system, the global coordinates system, the camera coordinates system, and the screen coordinates system. In the virtual-reality scene, the virtual object models is created in the local coordinates system, so it can be transformed by matrix transformation into a global coordinates system and then transformed by view transformation into the camera coordinates system, and then projected from the camera coordinates system to render virtual objects on the two-dimension screen.

Before the projection, it is needed to create a view rod to represent the field of view of the camera because the field of view of the camera is finite. The view rod may be represented by a projection matrix. The coordinate vector in the camera coordinates system of the virtual object models and the projection matrix may be projection transformed to obtain a cut coordinate vector in a cut coordinates system. With the cut coordinate vector, whether the virtual object model is in the view rod or not and the distance from the camera position may be checked.

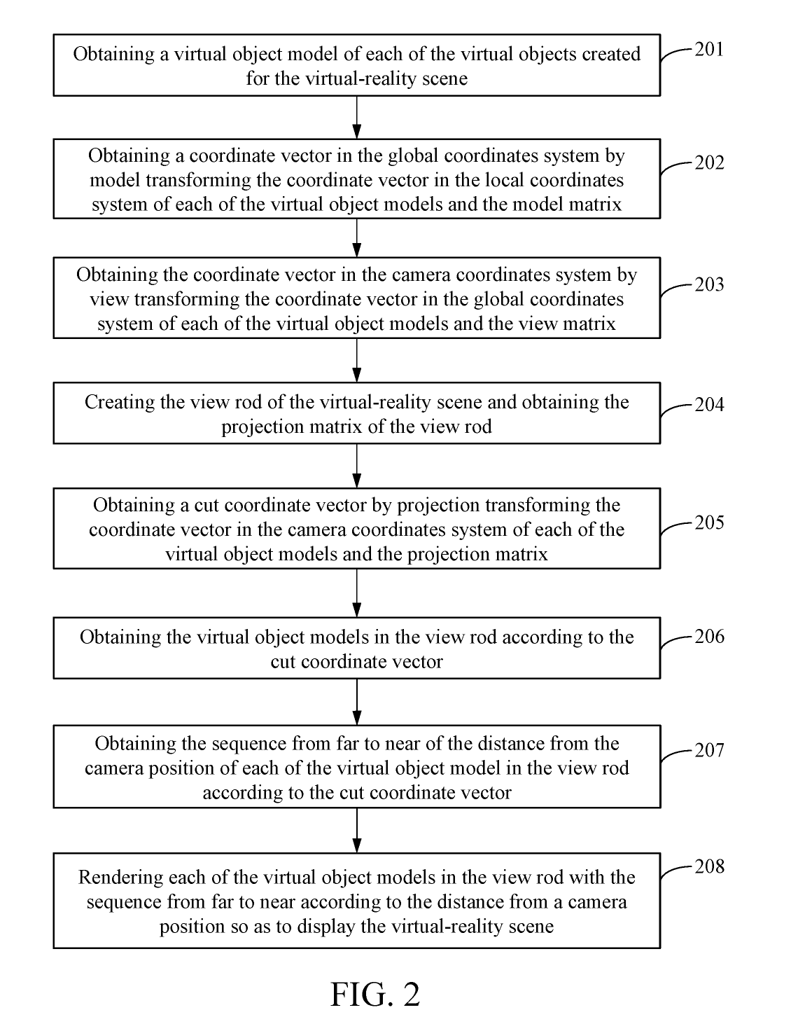

As shown in FIG. 2, which is a flowchart of a method for model rendering in another embodiment of the present application, the method may include the following steps:

201: the virtual object model of each of the virtual objects created for the virtual-reality scene is obtained.

202: the coordinate vector in the local coordinates system of each of the virtual object models and the model matrix is model transformed to obtain a coordinate vector in the global coordinates system.

Wherein, the model matrix represents the transformation information of the virtual object model and includes rotation, shifting, scaling, etc.

First, the transformation information such as rotation, shifting, and scaling in the global coordinates system of each of the virtual object model may be expressed as the model matrix in the global coordinates system.

The coordinate vector in the local coordinates system of each of the virtual object models and the model matrix is model transformed to obtain the coordinate vector in the global coordinates system of the virtual object model.

The view product of the coordinate vector in the local coordinates system and the model matrix may be calculated to transform the coordinate vector in the local coordinates system into the global coordinates system.

Specifically, the coordinate vector in the global coordinates system may be obtained by model transformation with the formula as:

$$( \begin{matrix}Xworld \\ Yworld \\ Zworld \\ Wworld\end{matrix} ) = Mmodel . transport ( ) * ( \begin{matrix}Xobj \\ Yobj \\ Zobj \\ Wobj\end{matrix} ) ;$$

Wherein,

$$( \begin{matrix}Xobj \\ Yobj \\ Zobj \\ Wobj\end{matrix} )$$

is the coordinate vector in the local coordinates system of the virtual object model,

$$( \begin{matrix}Xworld \\ Yworld \\ Zworld \\ Wworld\end{matrix} )$$

is the coordinate vector in the global coordinates system of the virtual object model, Mmodel.transport( ) represents a transpose of the model matrix.

Wherein, (Xobj, Yobj, Zobj) represents the coordinates in the local coordinates system of the virtual object model, and specifically the center coordinates, Wobj is the homogeneous coordinates in the local coordinates system, and Wobj is 0. (Xworld, Yworld, Zworld) represents the coordinates in the global coordinates system, Wworld is the homogeneous coordinates in the global coordinates system.

Wherein, the model matrix is the view product of the shifting matrix, the scaling matrix and the rotation matrix.

The shifting matrix is

$$( \begin{matrix}1 & 0 & 0 & {x}_{1} \\ 0 & 1 & 0 & {y}_{1} \\ 0 & 0 & 1 & {z}_{1} \\ 0 & 0 & 0 & 1\end{matrix} ) ;$$

x₁, y₁, z₁ are the distances moving along the x-axis, the y-axis, and the z-axis in the global coordinates system.

The scaling matrix is

$$( \begin{matrix}{x}_{2} & 0 & 0 & 0 \\ 0 & {y}_{2} & 0 & 0 \\ 0 & 0 & {z}_{2} & 0 \\ 0 & 0 & 0 & 1\end{matrix} ) ;$$

x₂, y₂, z₂ are the amounts of scaling along the x-axis, the y-axis, and the z-axis in the global coordinates system.

The rotation matrix is the view product of the matrix rotating around the x-axis, the y-axis, and the z-axis in the global coordinates system:

Wherein, the matrix rotating around the x-axis with the angle A is represented as:

$$( \begin{matrix}1 & 0 & 0 & 0 \\ 0 & cos ( A ) & - sin ( A ) & 0 \\ 0 & sin ( A ) & cos ( A ) & 0 \\ 0 & 0 & 0 & 1\end{matrix} ) ;$$

Wherein, the matrix rotating around the y-axis with the angle A is represented as:

$$( \begin{matrix}cos ( A ) & 0 & sin ( A ) & 0 \\ 0 & 1 & 0 & 0 \\ - sin ( A ) & 0 & cos ( A ) & 0 \\ 0 & 0 & 0 & 1\end{matrix} ) ;$$

Wherein, the matrix rotating around the z-axis with the angle A is represented as:

$$( \begin{matrix}cos ( A ) & - sin ( A ) & 0 & 0 \\ sin ( A ) & cos ( A ) & 0 & 0 \\ 0 & 0 & 1 & 0 \\ 0 & 0 & 0 & 1\end{matrix} ) ;$$

The homogeneous coordinates is an important means in computer graphology. It can tell the vector from the point clearly, and perform the linear geometry transformation more easily.

203: the coordinate vector in the global coordinates system of each of the virtual object models and the view matrix are view transformed to obtain the coordinate vector in the camera coordinates system.

The local coordinates system may be transformed into the global coordinates system by model transformation. The global coordinates system may be transformed into the camera coordinates system by view transformation.

The camera may be expressed in the three-dimension space with a camera position, a camera orientation vector, and a camera forward vector, so the view matrix may be obtained according to the camera position, the camera orientation vector, and the camera forward vector.

The view matrix may treat the user as a model to obtain an inverse matrix of the transformed model matrix in the global coordinates system of the user.

the step of obtaining the coordinate vector in the camera coordinates system by view transforming the coordinate vector in the global coordinates system of each virtual object model and the view matrix comprises:

obtaining the coordinate vector in the camera coordinates system by view transforming the view matrix of the camera coordinates system and the coordinate vector in the global coordinates system of each of the virtual object model with a formula as:

$$( \begin{matrix}Xeye \\ Yeye \\ Zeye \\ Weye\end{matrix} ) = ViewMatrix . transport ( ) * ( \begin{matrix}Xworld \\ Yworld \\ Zworld \\ Wworld\end{matrix} ) ;$$

Wherein,

$$( \begin{matrix}Xeye \\ Yeye \\ Zeye \\ Weye\end{matrix} )$$

represents the coordinate vector in the camera coordinates system of the virtual object model; Weye is the homogeneous coordinates in the camera coordinates system of the virtual object model; ViewMatrix.transport( ) represents a transpose of the view matrix.

Wherein, the view matrix may be obtained with a formula as:

Assume the camera position is Vector3 eye; the camera orientation vector is Vector3 at; and the camera forward vector is Vector3 up.

Vector3 forward, side;

forward=at−eye;

normalize(forward);

side=cross(forward, up);

normalize(side);

up=cross(side, forward);

Then the view matrix is calculated as:

$$( \begin{matrix}side . x & up . x & - forward . x & 0 \\ side . y & up . x & - forword . x & 0 \\ side . z & up . z & - forword . x & 0 \\ 0 & 0 & 0 & 1\end{matrix} ) ;$$

In the code above, cross represents cross, and normalize represents normalize.

204: the view rod of the virtual-reality scene is created and the projection matrix of the view rod is obtained.

The area of the cut plane is defined by left, right, bottom, and top, and the distances from the camera to the near cut plane and the far cut plane are defined by zNear and zFar. The rod constructed by the six cut planes defined by the six parameters is the view rod, and is also called as frustum.

The view rod may be expressed as a projection matrix according to the six parameters of the view rod.

205: a cut coordinate vector is obtained by projection transforming the coordinate vector in the camera coordinates system of each of the virtual object models and the projection matrix.

Specifically, the cut coordinate vector of the virtual object model is obtained by projection transforming the coordinate vector in the camera coordinates system of each of the virtual object models and the projection matrix with the projection transformation formula as:

$$( \begin{matrix}Xclip \\ Yclip \\ Zclip \\ Wclip\end{matrix} ) = ProjectionMatrix . transport ( ) * ( \begin{matrix}Xeye \\ Yeye \\ Zeye \\ Weye\end{matrix} ) ;$$

Wherein,

$$( \begin{matrix}Xclip \\ Yclip \\ Zclip \\ Wclip\end{matrix} )$$

is the cut coordinate vector, ProjectionMatrix.transport( ) represents a transpose of the projection matrix, (Xclip, Yclip, Zclip, Wclip) is the cut coordinates; Wclip is the homogeneous coordinates in the cut coordinates.

Wherein, assume top=t; Bottom=b; Left=l; Right=r; Near=n; Far=f.

The projection matrix is:

$$( \begin{matrix}\frac{2 n}{r - t} & 0 & \frac{r + l}{r - l} & 0 \\ 0 & \frac{2 n}{t - b} & \frac{t + b}{t - b} & 0 \\ 0 & 0 & \frac{- ( f + n )}{f - n} & \frac{- 2 fn}{f - n} \\ 0 & 0 & - 1 & 0\end{matrix} ) ;$$

206: the virtual object models in the view rod are obtained according to the cut coordinate vector.

Wclip represents the distance between the virtual object model and the view rod.

If Wclip is 0, it means that the corresponding virtual object model is not in the view rod.

Hence, it may be checked that the virtual object models with non-zero homogeneous coordinates are in the view rod according to the homogeneous coordinates in the cut coordinate vector.

207: the sequence from far to near of the distance from the camera position of each of the virtual object model in the view rod is obtained according to the cut coordinate vector.

The value of Wclip represents the distance of each of the virtual object models from the camera position. The larger the value of Wclip, the larger the distance between the virtual object model and the camera position is.

Specifically, the virtual objects in the view rod are ranked according to the homogeneous coordinates in the cut coordinate vector from large to small, so the sequence from far to near of each of the virtual object models in the view rod according to the distance from the camera position is obtained.

208: each of the virtual object models in the view rod is rendered with the sequence from far to near according to the distance from a camera position so as to display the virtual-reality scene.

That is, each of the virtual object models in the view rod is ranked with a sequence from large to small according to the homogeneous coordinates, and is rendered with the sequence to display the virtual-reality scene.

In one embodiment of the present application, the coordinate vector in the camera coordinates system of the virtual object model is obtained by view transforming the virtual object model. The virtual object models in a view rod are obtained by creating the view rod. The cut coordinate vector of the virtual object model may be obtained according to the projection matrix of the view rod and the coordinate vector in the camera coordinates system of the virtual object model. The virtual object models in the view rod may be checked according to the cut coordinate vector, and so as the distance from the camera position of the virtual object models in the view rod. Hence, the virtual objects in the view rod are rendered with the sequence from far to near according to the distance from the camera, so the rendering efficiency is improved. Further, the virtual object model closer to the camera is rendered later and is not blocked so as to improve the display effect of rendering.

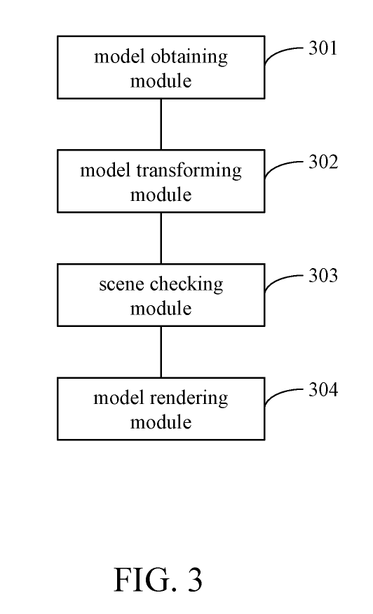

FIG. 3 is a schematic of a device for model rendering in one embodiment of the present application. The device specifically applied in the display terminal and the device may include:

A model obtaining module 301 is used for obtaining virtual object models of virtual objects built for a virtual-reality (VR) scene.

A model transforming module 302 is used for transforming a coordinate vector in a local coordinates system of each of virtual object model into a coordinate vector in a camera coordinates system.

The camera coordinates system is also called the eye coordinates system, and refers to a vision space of watching objects by camera lens or eyes.

Because the virtual object model is created in the local coordinates system, it is needed to transform the virtual object model into the camera coordinates system for implementing the display of the virtual objects. Specifically, the coordinate vector in the local coordinates system of each of the virtual object models is transformed into the coordinate vector in the camera coordinates system.

The coordinate vector may be corresponding to the coordinates of any point in the virtual object model. For the sake of accuracy of computation, it may be corresponding to the center coordinates of the virtual object model.

Specifically, transforming the coordinate vector in the local coordinates system of the virtual object model into the coordinate vector in the camera coordinates system may be implemented by matrix transformation.

A scene checking module 303 is used for creating a view rod of the virtual-reality scene to obtain the virtual object models in the view rod according to the view rod and the coordinate vector in the camera coordinates system of each of the virtual object models

Because the field of vision of the camera is not infinite, so it's needed to create a view rod. The objects in the view rod can be projected to the view plane and the objects out of the view rod will be discarded.

The view rod may be represented by a matrix, and that is, a projection matrix. Hence, the virtual object models in the view rod may be obtained according to the coordinate vector in the camera coordinates system of each of the virtual object models and the projection matrix of the view rod.

A model rendering module 304 is used for rendering each of the virtual object models in the view rod with a sequence from far to near according to a distance from a camera position so as to display the virtual-reality scene

The virtual object models in the view rod are checked, and they are rendered with the sequence from far to near according to the distance from the camera position. That is, the virtual object models are projected from the camera coordinates system to the two-dimension screen to render graph on the two-dimension screen, so the display of the virtual-reality scene is implemented.

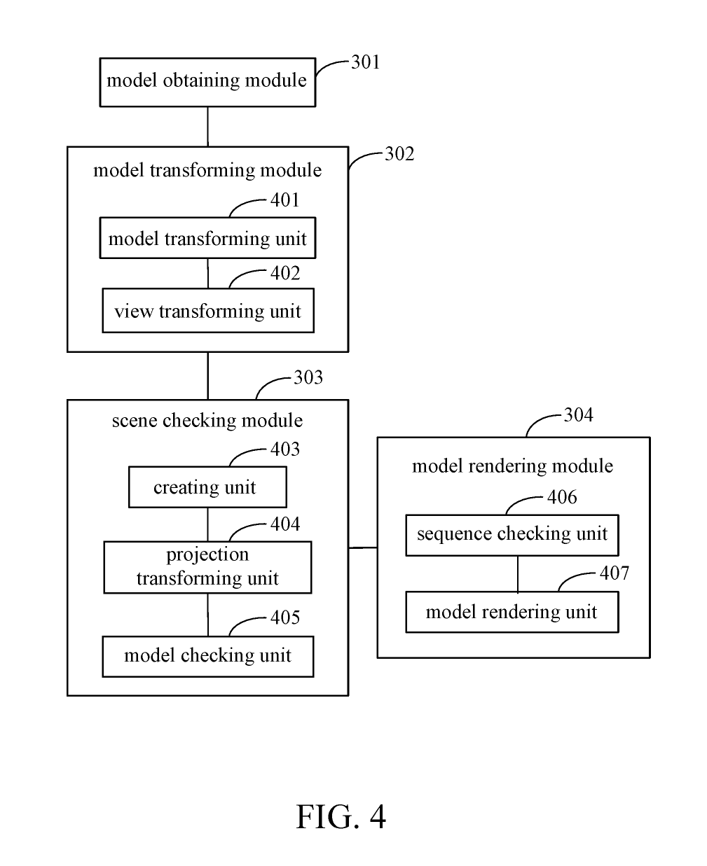

In one embodiment of the present application, each of the virtual object models in the virtual-reality scene is transformed into the camera coordinates system by coordinates transformation, and then the view rod is created. Only the virtual object models in the view rod are rendered and projected from the camera coordinates system to the two-dimension screen to render each of the virtual objects. The virtual object models out of the view rod are discarded so the efficiency of rendering is improved. Further, each virtual object is rendered with the sequence from far to near according to the distance from the camera, so the virtual object model closer to the camera is rendered later and wouldn't be blocked. Hence, the display effect of rendering is improved.

Wherein, as another embodiment as shown in FIG. 4, the model transforming module 302 may include:

A model transforming unit 401 is for obtaining a coordinate vector in a global coordinates system by model transforming the coordinate vector in the local coordinates system of each virtual object model and a model matrix;

A view transforming unit 402 is used for obtaining the coordinate vector in the camera coordinates system by view transforming the coordinate vector in the global coordinates system of each virtual object model and a view matrix.

In the virtual-reality scene, the virtual object models is created in the local coordinates system, so it can be transformed by matrix transformation into a global coordinates system and then transformed by view transformation into the camera coordinates system.

In another embodiment, the model transforming unit is specifically used for:

expressing rotation information, shifting information and scaling information in the global coordinates system of each of the virtual object model as the model matrix in the global coordinates system; and obtaining the coordinate vector in the global coordinates system by model transforming the coordinate vector in the local coordinates system of each of the virtual object models and the model matrix with a model transformation formula as:

$$( \begin{matrix}Xworld \\ Yworld \\ Zworld \\ Wworld\end{matrix} ) = Mmodel . transport ( ) * ( \begin{matrix}Xobj \\ Yobj \\ Zobj \\ Wobj\end{matrix} ) ;$$

Wherein

$$( \begin{matrix}Xobj \\ Yobj \\ Zobj \\ Wobj\end{matrix} ) .$$

is the coordinate vector in the local coordinates system of the virtual object model,

$$( \begin{matrix}Xworld \\ Yworld \\ Zworld \\ Wworld\end{matrix} )$$

is the coordinate vector in the global coordinates system of the virtual object model, Mmodel.transport( ) represents a transpose of the model matrix; Wobj is homogeneous coordinates in the local coordinates system of the virtual object model, Wworld is homogeneous coordinates in the global coordinates system of the virtual object model;

the view transforming unit is specifically used for:

obtaining the view matrix according to the camera position, a camera orientation vector, and a camera forward vector;

obtaining the coordinate vector in the camera coordinates system by view transforming the view matrix of the camera coordinates system and the coordinate vector in the global coordinates system of each of the virtual object model with a formula as:

$$( \begin{matrix}Xeye \\ Yeye \\ Zeye \\ Weye\end{matrix} ) = ViewMatrix . transport ( ) * ( \begin{matrix}Xworld \\ Yworld \\ Zworld \\ Wworld\end{matrix} ) ;$$

Wherein

$$( \begin{matrix}Xeye \\ Yeye \\ Zeye \\ Weye\end{matrix} ) .$$

represents the coordinate vector in the camera coordinates system of the virtual object model; Weye is homogeneous coordinates in the camera coordinates system of the virtual object model; and ViewMatrix.transport( ) represents a transpose of the view matrix.

Before the projection, it is needed to create a view rod to represent the field of view of the camera because the field of view of the camera is finite. The view rod may be expressed as a projection matrix. The cut coordinate vector in the cut coordinates system may be obtained by projection transforming the coordinate vector in the camera coordinates system of the virtual object model and the projection matrix. With the cut coordinate vector, whether the virtual object model is in the view rod or not and the distance between the virtual object model and the camera position may be checked. Hence, as another embodiment, as shown in FIG. 4, the scene checking module 303 may include:

A creating unit 403 is used for creating the view rod of the virtual-reality scene and obtaining a projection matrix of the view rod.

The area of the cut plane is defined by left, right, bottom, and top, and the distances from the camera to the near cut plane and the far cut plane are defined by zNear and zFar. The rod constructed by the six cut planes defined by the six parameters is the view rod, and is also called as frustum.

The view rod may be expressed as a projection matrix according to the six parameters of the view rod.

a projection transforming unit 404 is used for obtaining a cut coordinate vector by projection transforming the coordinate vector in the camera coordinates system of each of the virtual object models and the projection matrix.

Specifically, the cut coordinate vector of the virtual object model is obtained by projection transforming the coordinate vector in the camera coordinates system of each of the virtual object models and the projection matrix with a formula as:

$$( \begin{matrix}Xclip \\ Yclip \\ Zclip \\ Wclip\end{matrix} ) = ProjectionMatrix . transport ( ) * ( \begin{matrix}Xeye \\ Yeye \\ Zeye \\ Weye\end{matrix} ) ;$$

Wherein

$$( \begin{matrix}Xclip \\ Yclip \\ Zclip \\ Wclip\end{matrix} )$$

is the cut coordinate vector of the virtual object model, ProjectionMatrix.transport( ) represents a transpose of the projection matrix, (Xclip, Yclip, Zclip, Wclip) is the cut coordinates, and Wclip is homogeneous coordinates of the cut coordinate vector.

A model checking unit 405 is used for obtaining the virtual object models in the view rod according to the cut coordinate vector.

Wclip represents the distance between the virtual object model and the view rod.

If Wclip is 0, it means that the corresponding virtual object model is not in the view rod.

Hence, it may be checked that the virtual object models with non-zero homogeneous coordinates are in the view rod according to the homogeneous coordinates in the cut coordinate vector.

The model rendering module 304 may include:

A sequence checking unit 406 is for obtaining the sequence from far to near according to the distance from the camera position of each of the virtual object models in the view rod according to the cut coordinate vector.

The value of Wclip represents the distance of each of the virtual object models from the camera position. The larger the value of Wclip, the larger the distance between the virtual object model and the camera position is.

Specifically, the virtual objects in the view rod are ranked according to the homogeneous coordinates in the cut coordinate vector from large to small, so the sequence from far to near of each of the virtual object models in the view rod according to the distance from the camera position is obtained.

A model rendering unit 407 is for rendering each of the virtual object models in the view rod with the sequence from far to near according to the distance from the camera position so as to display the virtual-reality scene.

That is, each of the virtual object models in the view rod is ranked with a sequence from large to small according to the homogeneous coordinates, and is rendered with the sequence to display the virtual-reality scene.

In one embodiment of the present application, the coordinate vector in the camera coordinates system of the virtual object model is obtained by view transforming the virtual object model. The virtual object models in a view rod are obtained by creating the view rod. The cut coordinate vector of the virtual object model may be obtained according to the projection matrix of the view rod and the coordinate vector in the camera coordinates system of the virtual object model. The virtual object models in the view rod may be checked according to the cut coordinate vector, and so as the distance from the camera position of the virtual object models in the view rod. Hence, the virtual objects in the view rod are rendered with the sequence from far to near according to the distance from the camera, so the rendering efficiency is improved. Further, the virtual object model closer to the camera is rendered later and is not blocked so as to improve the display effect of rendering.

The above-mentioned embodiment of device is exemplary, and the unit illustrated as the eliminated element may not be eliminated physically. The element displayed as a unit may not be a physical unit located in one place; otherwise, the element may be distributed at many network units. Part or all modules may be selected according to real need to implement the purpose of the solution of the present embodiment. One having ordinary skill in the art is capable of understanding and implementing the present disclosure without creative dedication.

One embodiment of the present application further provides a non-volatile computer-readable storage medium. The computer-readable storage medium stores computer-executable instructions, and the computer-executable instructions are capable of performing the method for model rendering in any of the method embodiments.

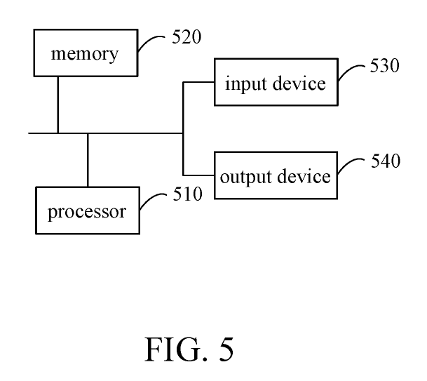

FIG. 5 is hardware architecture of an electronic device for model rendering in one embodiment of the present application. The device includes:

One or more processor 510 and a memory 520, and FIG. 5 is an example for one processor 510.

The device performing the method for model rendering may further includes: an input device 530 and an output device 540.

The processor 510, the memory 520, the input device 530, and the output device 540 may be in connection with each other via a bus or other means, and FIG. 5 is an example for connection via the bus.

The memory 520, as a non-volatile computer-readable storage medium, is capable of being used for storing non-volatile software process, non-volatile computer-executable process and modules such as the process instructions and modules corresponding to the method for model rendering in one embodiment of the present application. The processor 510 performs the functionalities and data processing of a server to implement the method for model rendering in the aforementioned method embodiment by executing the non-volatile software process, instructions, and modules stored in the memory 520.

The memory 520 can include program storage sections and data storage sections, wherein the program storage sections can store an operating system and at least one application program required for a function; the data storage sections can store the data created according to the usage of the device for model rendering. Furthermore, the memory 520 can include a high speed random-access memory, and further include a non-volatile memory such as at least one disk storage member, at least one flash memory member and other non-volatile solid state storage member. In some embodiments, the memory 520 can have a remote connection with the processor 510, and such memory can be connected to the device for model rendering by a network. The aforementioned network includes, but not limited to, internet, intranet, local area network, mobile communication network and combination thereof.

The input device 530 can receive digital or character information, and generate a key signal input corresponding to the user setting and the function control of the device for model rendering. The output device 540 can include a displaying unit such as screen.

The one or more modules are stored in the memory 520. When the one or more modules are executed by one or more processor 510, the method for model rendering disclosed in any one of the embodiments is performed.

The aforementioned product may perform the method provided in one embodiment of the present application and have the functional module and benefit corresponding to performing the method. The technical details not described in the embodiment may refer to the method provided in the embodiment of the present application.

The electronic apparatus in the embodiments of the present application is presence in many forms, and the electronic apparatus includes, but not limited to:

(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.

(2) Ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.

(3) Portable entertainment apparatus: this type of apparatus can display and play multimedia contents. This type of apparatus includes: audio, video player (e.g. iPod), handheld game console, e-books, as well as smart toys and portable vehicle-mounted navigation apparatus.

(4)Server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.

(5) Other electronic apparatus having a data exchange function.

The above-mentioned embodiment of device is exemplary, and the unit illustrated as the eliminated element may not be eliminated physically. The element displayed as a unit may not be a physical unit located in one place; otherwise, the element may be distributed at many network units. Part or all modules may be selected according to real need to implement the purpose of the solution of the present embodiment. One having ordinary skill in the art is capable of understanding and implementing the present disclosure without creative dedication.

Through the above descriptions of embodiments, those skilled in the art can clearly realize each embodiment can be implemented using software plus essential common hardware platforms. Certainly each embodiment can be implemented using hardware. Based on the understanding, the above technical solutions or part of the technical solutions contributing to the prior art could be embodied in form of software products. The computing software products can be stored in a computer-readable storage medium such as ROM/RAM, disk, compact disc, etc. The computing software products include several instructions configured to make a computing device (a personal computer, a server, or internet device, etc) carry out the methods in each embodiments or part of methods in the embodiments.

Finally, it should be noted that: the above embodiments are just used for illustrating the technical solutions of the present disclosure and not for limiting the present disclosure. Even though the present disclosure is illustrated clearly referring to the previous embodiments, persons having ordinary skills in the art should realize the technical solutions described in the aforementioned embodiments can be modified or part of technical features can be displaced equivalently. The modification or the displacement would not make corresponding essentials of the technical solutions out of spirit and scope of the technical solution of each embodiment of the present disclosure.

1. A method for model rendering, characterized by applied in a terminal, comprising:
obtaining virtual object models of virtual objects built for a virtual-reality scene;
transforming a coordinate vector in a local coordinates system of each virtual object into a coordinate vector in a camera coordinates system;
creating a view rod of the virtual-reality scene to obtain the virtual object models in the view rod according to the view rod and the coordinate vector in the camera coordinates system of each of the virtual object models; and
rendering each of the virtual object models in the view rod with a sequence from far to near according to a distance from a camera position so as to display the virtual-reality scene.

2. The method according to claim 1, characterized by, wherein the step of transforming the coordinate vector in the local coordinates system of each virtual object into the coordinate vector in the camera coordinates system comprises:
obtaining a coordinate vector in a global coordinates system by model transforming the coordinate vector in the local coordinates system of each virtual object model and a model matrix; and
obtaining the coordinate vector in the camera coordinates system by view transforming the coordinate vector in the global coordinates system of each virtual object model and a view matrix.

3. The method according to claim 1, characterized by, wherein the step of creating the view rod of the virtual-reality scene to obtain the virtual object models in the view rod according to the view rod and the coordinate vector in the camera coordinates system of each of the virtual object models comprises:
creating the view rod of the virtual-reality scene and obtaining a projection matrix of the view rod;
obtaining a cut coordinate vector by projection transforming the coordinate vector in the camera coordinates system of each of the virtual object models and the projection matrix; and
obtaining the virtual object models in the view rod according to the cut coordinate vector;
wherein the step of rendering each of the virtual object models in the view rod with the sequence from far to near according to the distance from the camera position so as to display the virtual-reality scene comprises:
obtaining the sequence from far to near according to the distance from the camera position of each of the virtual object models in the view rod according to the cut coordinate vector; and
rendering each of the virtual object models in the view rod with the sequence from far to near according to the distance from the camera position so as to display the virtual-reality scene.

4. The method according to claim 3, characterized by, the step of obtaining the coordinate vector in the global coordinates system by model transforming according to the coordinate vector in the local coordinates system of each virtual object model and the model matrix of each virtual object model comprises:
expressing rotation information, shifting information and scaling information in the global coordinates system of each of the virtual object model as the model matrix in the global coordinates system;
obtaining the coordinate vector in the global coordinates system by model transforming the coordinate vector in the local coordinates system of each of the virtual object models and the model matrix with a model transformation formula as:
$$( \begin{matrix}Xworld \\ Yworld \\ Zworld \\ Wworld\end{matrix} ) = Mmodel . transport ( ) * ( \begin{matrix}Xobj \\ Yobj \\ Zobj \\ Wobj\end{matrix} ) ;$$
wherein
$$( \begin{matrix}Xobj \\ Yobj \\ Zobj \\ Wobj\end{matrix} )$$
is the coordinate vector in the local coordinates system of the virtual object model,
$$( \begin{matrix}Xworld \\ Yworld \\ Zworld \\ Wworld\end{matrix} )$$
is the coordinate vector in the global coordinates system of the virtual object model, Mmodel.transport( ) represents a transpose of the model matrix; Wobj is homogeneous coordinates in the local coordinates system of the virtual object model, Wworld is homogeneous coordinates in the global coordinates system of the virtual object model;
wherein the step of obtaining the coordinate vector in the camera coordinates system by view transforming the coordinate vector in the global coordinates system of each virtual object model and the view matrix comprises:
obtaining the view matrix according to the camera position, a camera orientation vector, and a camera forward vector;
obtaining the coordinate vector in the camera coordinates system by view transforming the view matrix of the camera coordinates system and the coordinate vector in the global coordinates system of each of the virtual object model with a formula as:
$$( \begin{matrix}Xeye \\ Yeye \\ Zeye \\ Weye\end{matrix} ) = ViewMatrix . transport ( ) * ( \begin{matrix}Xworld \\ Yworld \\ Zworld \\ Wworld\end{matrix} ) ;$$
wherein
$$( \begin{matrix}Xeye \\ Yeye \\ Zeye \\ Weye\end{matrix} ) .$$
represents the coordinate vector in the camera coordinates system of the virtual object model; Weye is homogeneous coordinates in the camera coordinates system of the virtual object model; and ViewMatrix.transport( ) represents a transpose of the view matrix.

5. The method according to claim 3, characterized by, wherein the step of obtaining the cut coordinate vector by projection transforming the coordinate vector in the camera coordinates system of each of the virtual object models and the projection matrix comprises:
obtaining the cut coordinate vector of the virtual object model by projection transforming the coordinate vector in the camera coordinates system of each of the virtual object models and the projection matrix with a formula as:
$$( \begin{matrix}Xclip \\ Yclip \\ Zclip \\ Wclip\end{matrix} ) = ProjectionMatrix . transport ( ) * ( \begin{matrix}Xeye \\ Yeye \\ Zeye \\ Weye\end{matrix} ) ;$$
wherein
$$( \begin{matrix}Xclip \\ Yclip \\ Zclip \\ Wclip\end{matrix} )$$
is the cut coordinate vector of the virtual object model, ProjectionMatrix.transport( ) represents a transpose of the projection matrix, and Wclip is homogeneous coordinates of the cut coordinate vector;
wherein the step of obtaining the virtual object models in the view rod according to the cut coordinate vector comprises:
checking that the virtual object model with non-zero homogeneous coordinates is in the view rod according to the homogeneous coordinates of the cut coordinates vector;
wherein the step of obtaining the sequence from far to near according to the distance from the camera position of each of the virtual object models in the view rod according to the cut coordinate vector comprises:
obtaining the sequence from far to near according to the distance from the camera position of each of the virtual object models in the view rod by arranging each of the virtual object models in the view rod according to the homogeneous coordinates from large to small according to the homogeneous coordinates of the cut coordinate vector;
wherein the step of rendering each of the virtual object models in the view rod with the sequence from far to near according to the distance from the camera position so as to display the virtual-reality scene comprises:
rendering each of the virtual object models in the view rod according the homogeneous coordinates with a sequence from large to small so as to display the virtual-reality scene.

6. A non-volatile computer-readable storage medium storing computer-executable instructions, characterized by, wherein the computer-executable instructions are set for:
obtaining virtual object models of virtual objects built for a virtual-reality scene;
transforming a coordinate vector in a local coordinates system of each virtual object into a coordinate vector in a camera coordinates system;
creating a view rod of the virtual-reality scene to obtain the virtual object models in the view rod according to the view rod and the coordinate vector in the camera coordinates system of each of the virtual object models; and
rendering each of the virtual object models in the view rod with a sequence from far to near according to a distance from a camera position so as to display the virtual-reality scene.

7. An electronic device, characterized by, comprising:
at least one processor; and
a memory communicably connected with the at least one processor for storing instructions executable by the at least one processor, wherein execution of the instructions by the at least one processor causes the at least one processor to:
obtain virtual object models of virtual objects built for a virtual-reality scene;
transform a coordinate vector in a local coordinates system of each virtual object into a coordinate vector in a camera coordinates system;
create a view rod of the virtual-reality scene to obtain the virtual object models in the view rod according to the view rod and the coordinate vector in the camera coordinates system of each of the virtual object models; and
render each of the virtual object models in the view rod with a sequence from far to near according to a distance from a camera position so as to display the virtual-reality scene.

8. The non-volatile computer-readable storage medium according to claim 6, characterized by, wherein the step of transforming the coordinate vector in the local coordinates system of each virtual object into the coordinate vector in the camera coordinates system comprises:
obtaining a coordinate vector in a global coordinates system by model transforming the coordinate vector in the local coordinates system of each virtual object model and a model matrix; and
obtaining the coordinate vector in the camera coordinates system by view transforming the coordinate vector in the global coordinates system of each virtual object model and a view matrix.

9. The non-volatile computer-readable storage medium according to claim 6, characterized by, wherein the step of creating the view rod of the virtual-reality scene to obtain the virtual object models in the view rod according to the view rod and the coordinate vector in the camera coordinates system of each of the virtual object models comprises:
creating the view rod of the virtual-reality scene and obtaining a projection matrix of the view rod;
obtaining a cut coordinate vector by projection transforming the coordinate vector in the camera coordinates system of each of the virtual object models and the projection matrix; and
obtaining the virtual object models in the view rod according to the cut coordinate vector;
wherein the step of rendering each of the virtual object models in the view rod with the sequence from far to near according to the distance from the camera position so as to display the virtual-reality scene comprises:
obtaining the sequence from far to near according to the distance from the camera position of each of the virtual object models in the view rod according to the cut coordinate vector; and
rendering each of the virtual object models in the view rod with the sequence from far to near according to the distance from the camera position so as to display the virtual-reality scene.

10. The non-volatile computer-readable storage medium according to claim 9, characterized by, the step of obtaining the coordinate vector in the global coordinates system by model transforming according to the coordinate vector in the local coordinates system of each virtual object model and the model matrix of each virtual object model comprises:
expressing rotation information, shifting information and scaling information in the global coordinates system of each of the virtual object model as the model matrix in the global coordinates system;
obtaining the coordinate vector in the global coordinates system by model transforming the coordinate vector in the local coordinates system of each of the virtual object models and the model matrix with a model transformation formula as:
$$( \begin{matrix}Xworld \\ Yworld \\ Zworld \\ Wworld\end{matrix} ) = Mmodel . transport ( ) * ( \begin{matrix}Xobj \\ Yobj \\ Zobj \\ Wobj\end{matrix} ) ;$$
wherein
$$( \begin{matrix}Xobj \\ Yobj \\ Zobj \\ Wobj\end{matrix} )$$
is the coordinate vector in the local coordinates system of the virtual object model,
$$( \begin{matrix}Xworld \\ Yworld \\ Zworld \\ Wworld\end{matrix} )$$
is the coordinate vector in the global coordinates system of the virtual object model, Mmodel.transport( ) represents a transpose of the model matrix; Wobj is homogeneous coordinates in the local coordinates system of the virtual object model, Wworld is homogeneous coordinates in the global coordinates system of the virtual object model;
wherein the step of obtaining the coordinate vector in the camera coordinates system by view transforming the coordinate vector in the global coordinates system of each virtual object model and the view matrix comprises:
obtaining the view matrix according to the camera position, a camera orientation vector, and a camera forward vector;
obtaining the coordinate vector in the camera coordinates system by view transforming the view matrix of the camera coordinates system and the coordinate vector in the global coordinates system of each of the virtual object model with a formula as:
$$( \begin{matrix}Xeye \\ Yeye \\ Zeye \\ Weye\end{matrix} ) . = ViewMatrix . transport ( ) * ( \begin{matrix}Xworld \\ Yworld \\ Zworld \\ Wworld\end{matrix} ) ;$$
wherein
$$( \begin{matrix}Xeye \\ Yeye \\ Zeye \\ Weye\end{matrix} ) .$$
represents the coordinate vector in the camera coordinates system of the virtual object model; Weye is homogeneous coordinates in the camera coordinates system of the virtual object model; and ViewMatrix.transport( ) represents a transpose of the view matrix.

11. The non-volatile computer-readable storage medium according to claim 9, characterized by, wherein the step of obtaining the cut coordinate vector by projection transforming the coordinate vector in the camera coordinates system of each of the virtual object models and the projection matrix comprises:
obtaining the cut coordinate vector of the virtual object model by projection transforming the coordinate vector in the camera coordinates system of each of the virtual object models and the projection matrix with a formula as:
$$( \begin{matrix}Xclip \\ Yclip \\ Zclip \\ Wclip\end{matrix} ) = ProjectionMatrix . transport ( ) * ( \begin{matrix}Xeye \\ Yeye \\ Zeye \\ Weye\end{matrix} ) . ;$$
wherein
$$( \begin{matrix}Xclip \\ Yclip \\ Zclip \\ Wclip\end{matrix} )$$
is the cut coordinate vector of the virtual object model, ProjectionMatrix.transport( ) represents a transpose of the projection matrix, and Wclip is homogeneous coordinates of the cut coordinate vector;
wherein the step of obtaining the virtual object models in the view rod according to the cut coordinate vector comprises:
checking that the virtual object model with non-zero homogeneous coordinates is in the view rod according to the homogeneous coordinates of the cut coordinates vector;
wherein the step of obtaining the sequence from far to near according to the distance from the camera position of each of the virtual object models in the view rod according to the cut coordinate vector comprises:
obtaining the sequence from far to near according to the distance from the camera position of each of the virtual object models in the view rod by arranging each of the virtual object models in the view rod according to the homogeneous coordinates from large to small according to the homogeneous coordinates of the cut coordinate vector;
wherein the step of rendering each of the virtual object models in the view rod with the sequence from far to near according to the distance from the camera position so as to display the virtual-reality scene comprises:
rendering each of the virtual object models in the view rod according the homogeneous coordinates with a sequence from large to small so as to display the virtual-reality scene.

12. The electronic device according to claim 7, characterized by, wherein the step to transform the coordinate vector in the local coordinates system of each virtual object into the coordinate vector in the camera coordinates system comprises:
obtaining a coordinate vector in a global coordinates system by model transforming the coordinate vector in the local coordinates system of each virtual object model and a model matrix; and
obtaining the coordinate vector in the camera coordinates system by view transforming the coordinate vector in the global coordinates system of each virtual object model and a view matrix.

13. The electronic device according to claim 7, characterized by, wherein the step to create the view rod of the virtual-reality scene to obtain the virtual object models in the view rod according to the view rod and the coordinate vector in the camera coordinates system of each of the virtual object models comprises:
creating the view rod of the virtual-reality scene and obtaining a projection matrix of the view rod;
obtaining a cut coordinate vector by projection transforming the coordinate vector in the camera coordinates system of each of the virtual object models and the projection matrix; and
obtaining the virtual object models in the view rod according to the cut coordinate vector;
wherein the step of rendering each of the virtual object models in the view rod with the sequence from far to near according to the distance from the camera position so as to display the virtual-reality scene comprises:
obtaining the sequence from far to near according to the distance from the camera position of each of the virtual object models in the view rod according to the cut coordinate vector; and
rendering each of the virtual object models in the view rod with the sequence from far to near according to the distance from the camera position so as to display the virtual-reality scene.

14. The electronic device according to claim 13, characterized by, the step to obtain the coordinate vector in the global coordinates system by model transforming according to the coordinate vector in the local coordinates system of each virtual object model and the model matrix of each virtual object model comprises:
expressing rotation information, shifting information and scaling information in the global coordinates system of each of the virtual object model as the model matrix in the global coordinates system;
obtaining the coordinate vector in the global coordinates system by model transforming the coordinate vector in the local coordinates system of each of the virtual object models and the model matrix with a model transformation formula as:
$$( \begin{matrix}Xworld \\ Yworld \\ Zworld \\ Wworld\end{matrix} ) = Mmodel . transport ( ) * ( \begin{matrix}Xobj \\ Yobj \\ Zobj \\ Wobj\end{matrix} ) ;$$
wherein
$$( \begin{matrix}Xobj \\ Yobj \\ Zobj \\ Wobj\end{matrix} )$$
is the coordinate vector in the local coordinates system of the virtual object model,
$$( \begin{matrix}Xworld \\ Yworld \\ Zworld \\ Wworld\end{matrix} )$$
is the coordinate vector in the global coordinates system of the virtual object model, Mmodel.transport( ) represents a transpose of the model matrix; Wobj is homogeneous coordinates in the local coordinates system of the virtual object model, Wworld is homogeneous coordinates in the global coordinates system of the virtual object model;
wherein the step of obtaining the coordinate vector in the camera coordinates system by view transforming the coordinate vector in the global coordinates system of each virtual object model and the view matrix comprises:
obtaining the view matrix according to the camera position, a camera orientation vector, and a camera forward vector;
obtaining the coordinate vector in the camera coordinates system by view transforming the view matrix of the camera coordinates system and the coordinate vector in the global coordinates system of each of the virtual object model with a formula as:
$$( \begin{matrix}Xeye \\ Yeye \\ Zeye \\ Weye\end{matrix} ) . = ViewMatrix . transport ( ) * ( \begin{matrix}Xworld \\ Yworld \\ Zworld \\ Wworld\end{matrix} ) ;$$
wherein
$$( \begin{matrix}Xeye \\ Yeye \\ Zeye \\ Weye\end{matrix} ) .$$
represents the coordinate vector in the camera coordinates system of the virtual object model; Weye is homogeneous coordinates in the camera coordinates system of the virtual object model; and ViewMatrix.transport( ) represents a transpose of the view matrix.

15. The electronic device according to claim 13, characterized by, wherein the step to obtain the cut coordinate vector by projection transforming the coordinate vector in the camera coordinates system of each of the virtual object models and the projection matrix comprises:
obtaining the cut coordinate vector of the virtual object model by projection transforming the coordinate vector in the camera coordinates system of each of the virtual object models and the projection matrix with a formula as:
$$( \begin{matrix}Xclip \\ Yclip \\ Zclip \\ Wclip\end{matrix} ) = ProjectionMatrix . transport ( ) * ( \begin{matrix}Xeye \\ Yeye \\ Zeye \\ Weye\end{matrix} ) . ;$$
wherein
$$( \begin{matrix}Xclip \\ Yclip \\ Zclip \\ Wclip\end{matrix} )$$
is the cut coordinate vector of the virtual object model, ProjectionMatrix.transport( ) represents a transpose of the projection matrix, and Wclip is homogeneous coordinates of the cut coordinate vector;
wherein the step of obtaining the virtual object models in the view rod according to the cut coordinate vector comprises:
checking that the virtual object model with non-zero homogeneous coordinates is in the view rod according to the homogeneous coordinates of the cut coordinates vector;
wherein the step of obtaining the sequence from far to near according to the distance from the camera position of each of the virtual object models in the view rod according to the cut coordinate vector comprises:
obtaining the sequence from far to near according to the distance from the camera position of each of the virtual object models in the view rod by arranging each of the virtual object models in the view rod according to the homogeneous coordinates from large to small according to the homogeneous coordinates of the cut coordinate vector;
wherein the step of rendering each of the virtual object models in the view rod with the sequence from far to near according to the distance from the camera position so as to display the virtual-reality scene comprises:
rendering each of the virtual object models in the view rod according the homogeneous coordinates with a sequence from large to small so as to display the virtual-reality scene.

16. The method according to claim 2, characterized by, wherein the step of creating the view rod of the virtual-reality scene to obtain the virtual object models in the view rod according to the view rod and the coordinate vector in the camera coordinates system of each of the virtual object models comprises:
creating the view rod of the virtual-reality scene and obtaining a projection matrix of the view rod;
obtaining a cut coordinate vector by projection transforming the coordinate vector in the camera coordinates system of each of the virtual object models and the projection matrix; and
obtaining the virtual object models in the view rod according to the cut coordinate vector;
wherein the step of rendering each of the virtual object models in the view rod with the sequence from far to near according to the distance from the camera position so as to display the virtual-reality scene comprises:
obtaining the sequence from far to near according to the distance from the camera position of each of the virtual object models in the view rod according to the cut coordinate vector; and
rendering each of the virtual object models in the view rod with the sequence from far to near according to the distance from the camera position so as to display the virtual-reality scene.

17. The non-volatile computer-readable storage medium according to claim 8, characterized by, wherein the step of creating the view rod of the virtual-reality scene to obtain the virtual object models in the view rod according to the view rod and the coordinate vector in the camera coordinates system of each of the virtual object models comprises:
creating the view rod of the virtual-reality scene and obtaining a projection matrix of the view rod;
obtaining a cut coordinate vector by projection transforming the coordinate vector in the camera coordinates system of each of the virtual object models and the projection matrix; and
obtaining the virtual object models in the view rod according to the cut coordinate vector;
wherein the step of rendering each of the virtual object models in the view rod with the sequence from far to near according to the distance from the camera position so as to display the virtual-reality scene comprises:
obtaining the sequence from far to near according to the distance from the camera position of each of the virtual object models in the view rod according to the cut coordinate vector; and
rendering each of the virtual object models in the view rod with the sequence from far to near according to the distance from the camera position so as to display the virtual-reality scene.

18. The electronic device according to claim 12, characterized by, wherein the step to create the view rod of the virtual-reality scene to obtain the virtual object models in the view rod according to the view rod and the coordinate vector in the camera coordinates system of each of the virtual object models comprises:
creating the view rod of the virtual-reality scene and obtaining a projection matrix of the view rod;
obtaining a cut coordinate vector by projection transforming the coordinate vector in the camera coordinates system of each of the virtual object models and the projection matrix; and
obtaining the virtual object models in the view rod according to the cut coordinate vector;
wherein the step of rendering each of the virtual object models in the view rod with the sequence from far to near according to the distance from the camera position so as to display the virtual-reality scene comprises:
obtaining the sequence from far to near according to the distance from the camera position of each of the virtual object models in the view rod according to the cut coordinate vector; and
rendering each of the virtual object models in the view rod with the sequence from far to near according to the distance from the camera position so as to display the virtual-reality scene.
